(19) United States
(12) Patent Application Publication
(10) Pub. No.: US 2015/0314402 A1
(43) Pub. Date: Nov. 5, 2015

(54) SYSTEM FOR FACILITATING WELDING IN AN ENCLOSED STRUCTURE

(71) Applicant: Caterpillar Inc., Peoria, IL (US)

(72) Inventors: Huijun Wang, Peoria, IL (US); Danny L. McCaherty, Washington, IL (US)

(73) Assignee: Caterpillar Inc., Peoria, IL (US)

(21) Appl. No.: 14/795,920

(22) Filed: Jul. 10, 2015

(51) Int. Cl. B23K 37/04

(52) U.S. Cl. CPC B23K 37/04

(57) ABSTRACT

A system for facilitating welding along an opening defined in a first plate of an enclosed structure is disclosed. The system includes a support device adapted to be inserted between the opening of the first plate. The support device includes a first support member and a second support member adjustably coupled to the first support member. The support device includes a magnet member adapted to detachably couple the second support member to a second plate of the enclosed structure. A pusher member is partially received within a channel of the first support member. A pin member is adapted to selectively engage with one of a plurality of teeth of the pusher member. A backing member is adapted to close the opening from within the enclosure. Further, a cord member is used to move the pusher member and bias the backing member into contact with the first plate.

### TECHNICAL FIELD

The present disclosure relates to a system for facilitating welding in an enclosed structure, and more particularly, to a system for facilitating welding along an opening defined in a plate of the enclosed structure.

### BACKGROUND

Enclosed structures, such as a boom member of a machine, may experience cracking failures due to prolonged operation. Such cracking failures are repaired by gouging and welding the enclosed structure at the crack location. In order to perform welding, a weld root opening is defined in a plate along the location of the crack in the enclosed structure. Further, a backing member made from a steel or nonmetallic material, such as a ceramic tile, is required to close the weld root opening from bottom of the plate and to perform welding operation along the weld root opening to repair the cracking failure in the enclosed structure. However, the enclosed structure does not provide any access for an operator to support the backing member from bottom of the plate and perform inspection of the weld seam. Thus, repairing of the enclosed structure by welding may become a complicated and time consuming process.

European Patent Number 1864744A1 (the '744 patent) discloses a clamping device for a weld seam-backing member. The clamping device includes a backing member pressing against two work pieces having a welding gap therebetween. A rod extends through the backing member and has an exposed upper portion extending through a narrower portion of the welding gap into a wider portion of the welding gap. An elastic element is mounted between a bottom face of the backing member and an abutting portion on a lower portion of the rod to bias the backing member to press against the work pieces. The upper portion includes a hooked section having a first width smaller than a width of the narrower portion and a second width perpendicular to and larger than the width of the narrower portion. The rod is turnable to a position in which the second width of the hooked section presses against the work pieces under the action of the elastic element. However, the clamping device of the '744 patent is used for supporting the backing device against two separate work pieces and not an enclosed structure. In particular, it may be difficult and time consuming to use the clamping device to support the backing member from within the enclosed structure.

### SUMMARY OF THE DISCLOSURE

In one aspect of the present disclosure, a system for facilitating welding along an opening defined in a first plate of an enclosed structure is disclosed. The enclosed structure further has a second plate spaced apart from the first plate. The system includes a support device adapted to be inserted between the opening of the first plate and supported on the second plate. The support device includes a first support member having a first end and a second end. The first support member defines a channel extending from the first end along a first direction. The support device further includes a second support member adjustably coupled to the first support member to adjust a length between a first end of the first support member and an end of the second support member distal to the first support member. The support device also includes a magnet member attached to the end of the second support member distal to the first support member. The magnet member is adapted to detachably couple the second support member to the second plate of the enclosed structure. The support system also includes a pusher member having a pushing portion and an elongate portion extending from the pushing portion. The elongate portion is adapted to be at least partly received within the channel. The elongate portion also includes a plurality of teeth. The support also includes housing coupled to the first support member proximal to the first end thereof.

The support device includes a pin member at least partly received within the housing. The pin member is adapted to selectively engage with one tooth of the plurality of teeth of the elongate portion to allow unidirectional incremental movement of the pusher member along a second direction opposite to the first direction. The pin member is disposed substantially perpendicular with respect to the elongate portion of the pusher member. The support device further includes a spring member received within the housing. The spring member is configured to bias the pin member into engagement with one tooth of the plurality of teeth of the elongate portion. The support device also includes a cord member coupled to the pusher member. The cord member is adapted to move the pusher member along the second direction. The system further includes a backing member adapted to close the opening from within the enclosure. The backing member is inserted through the opening and supported on the pushing portion of the pusher member. Further, the cord member is pulled to move the pusher member along the second direction to bias the backing member into contact with the first plate to close the opening from within the enclosure.

Other features and aspects of this disclosure will be apparent from the following description and the accompanying drawings.

### BRIEF DESCRIPTION OF THE DRAWINGS

FIG. 1 is a partial perspective view of an exemplary enclosed structure having an opening, according to an embodiment of the present disclosure;

FIG. 2 is a perspective view of a backing member of a system to close the opening from inside of the enclosed structure, according to an embodiment of the present disclosure;

FIG. 3 is a sectional view of a support device of the system, according to an embodiment of the present disclosure;

FIGS. 4A to 4C illustrate a partial sectional view of the support device of FIG. 3 in various configurations;

FIGS. 5 and 6 illustrate a method of disposing the support device within the enclosed structure, according to an embodiment of the present disclosure;

FIGS. 7A and 7B illustrate a method of disposing the backing member within the enclosed structure, according to an embodiment of the present disclosure; and

FIGS. 8 and 9 illustrate a method of engaging the system with the backing member, according to an embodiment of the present disclosure.

### DETAILED DESCRIPTION

Reference will now be made in detail to specific embodiments or features, examples of which are illustrated in the accompanying drawings. Wherever possible, corresponding or similar reference numbers will be used throughout the drawings to refer to the same or corresponding parts.

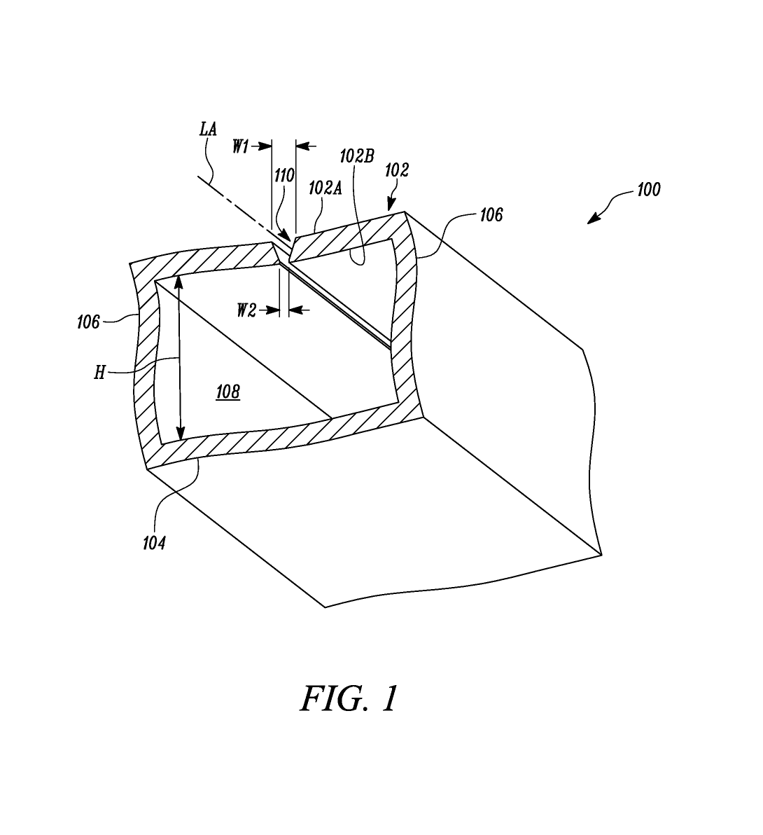

FIG. 1 illustrates a partial perspective view of an exemplary enclosed structure 100 requiring weld repairing. The enclosed structure 100 is used in various applications, such as off-road and on-road vehicles. In an example, the enclosed structure 100 may be an elongate member of a boom assembly used in excavator for performing earth moving operations. In an embodiment, the enclosed structure 100 may correspond to a hollow metallic structure having all sides closed such that inside of the hollow metallic structure is not accessible from outside of the hollow metallic structure. In other embodiments, the enclosed structure 100 may correspond to a metallic plate in a machine structure or any other structure having only one side accessible from outside. In various embodiments, the enclosed structure 100 may have any shape and size.

In the illustrated embodiment, the enclosed structure 100 is an elongate member having a first plate 102 and a second plate 104 spaced apart at a height ‘H’ from the first plate 102. The enclosed structure 100 further includes a pair of side plates 106 extending between the first plate 102 and the second plate 104 to define a space 108 within the enclosed structure 100. End plates of the enclosed structure 100 are not shown in FIG. 1 for clarity.

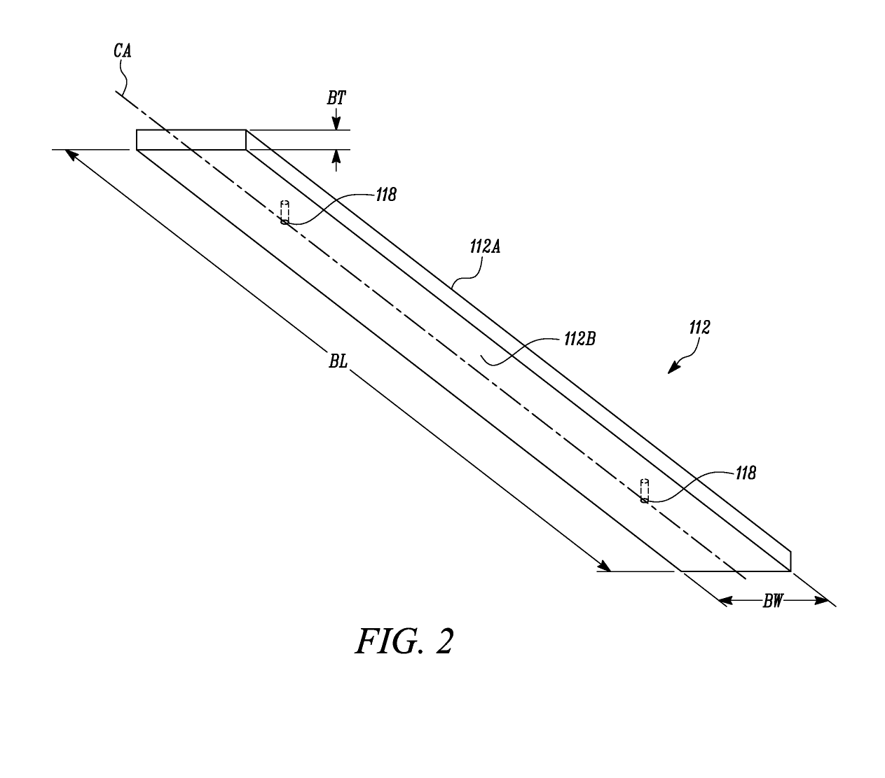

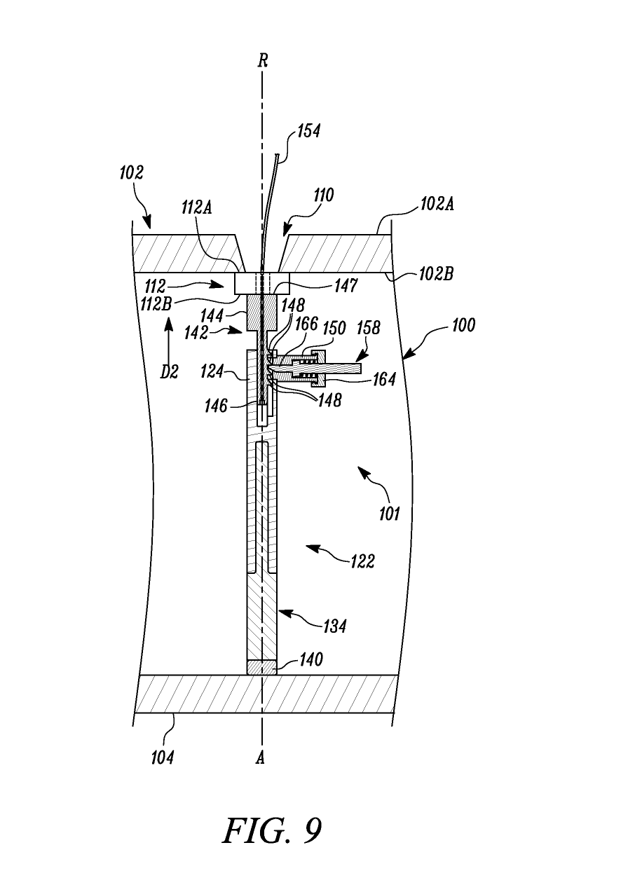

As shown in FIG. 1, an opening 110 is defined in the first plate 102. The opening 110 extends between an outer surface 102A and an inner surface 102B of the first plate 102. To facilitate welding of the first plate 102 along the opening 110, a system 101 (shown in FIG. 9) is disposed within the enclosed structure 100. The system 101 will be described in detail later with reference FIGS. 2 to 9. The opening 110 is defined in the enclosed structure 100 when repairing of the enclosed structure 100 is required due to damages, such as cracking failures, occurs due to prolonged operation. The opening 110 may be defined in the enclosed structure 100 along a direction of the crack (not shown) to remove the crack and form a weld seam along the opening 110.

In the illustrated embodiment, the opening 110 is defined longitudinally along a length of the first plate 102. Further, the opening 110 defines a longitudinal axis ‘LA’ along a length thereof. In an embodiment, the opening 110 has a first width ‘W1’ adjacent to the outer surface 102A of the first plate 102 and a second width ‘W2’ adjacent to the inner surface 102B of the first plate 102. In the illustrated embodiment, the second width ‘W2’ is less than the first width ‘W1’ of the opening 110. In other embodiments, the first width ‘W1’ and the second width ‘W2’ may be equal. In various embodiments, the first width ‘W1’ and the second width ‘W2’ of the opening 110 may vary based on various parameters including, but not limited to, a thickness of the first plate 102 and a thickness of the weld seam that is to be defined in the first plate 102.

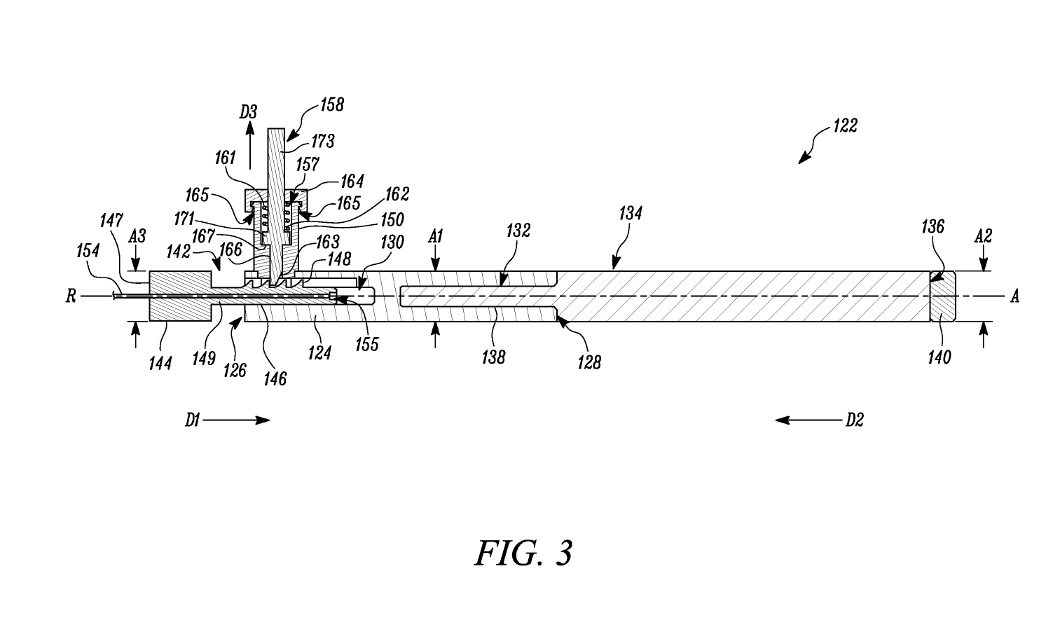

The opening 110 defined in the first plate 102 is closed by the system 101 from inside of the enclosed structure 100 for welding the first plate 102 along the opening 110. The system 101 includes a backing member 112 (shown in FIG. 2) for closing the opening 110 at the second width ‘W2’ and a support device 122 (shown in FIG. 3) for supporting the backing member 112 from inside of the enclosed structure 100.

FIG. 2 is a perspective view of the backing member 112, according to an embodiment of the present disclosure. Referring to FIGS. 1 and 2, the backing member 112 is adapted to be disposed adjacent to the inner surface 102B of the first plate 102 to close the opening 110 from inside of the enclosed structure 100. Thereafter, welding of the first plate 102 may be performed along the opening 110. In the illustrated embodiment, the backing member 112 is an elongate member having a length ‘BL’ and a width ‘BW’. The length ‘BL’ of the backing member 112 is longer than the length of the opening 110 and the width ‘BW’ of the backing member 112 is greater than the second width ‘W2’ of the opening 110. The backing member 112 includes a first surface 112A and a second surface 112B distal to the first surface 112A. The backing member 112 further defines a thickness ‘BT’ extending between the first surface 112A and the second surface 112B. The thickness ‘BT’ of the backing member 112 is less than the second width ‘W2’ of the opening 110. The first surface 112A of the backing member 112 is adapted to abut the inner surface 102B of the first plate 102 during welding of the first plate 102 along the opening 110.

Further, the backing member 112 includes a number of through holes 118 defined along a central axis ‘CA’. At least one through hole 118 is defined adjacent to both ends of the backing member 112. In the illustrated embodiment, the backing member 112 is made from a ceramic material. In another embodiment, the backing member 112 may be made from a combination of a ceramic plate and a steel plate. In such a case, the ceramic plate may be adapted to contact with the inner surface 102B of the first plate 102. In yet another embodiment, the backing member 112 may be made from multiple ceramic plates. Further, each of the ceramic plates may include at least one through hole 118.

FIG. 3 illustrates a sectional view of the support device 122 of the system 101, according to an embodiment of the present disclosure. Referring to FIGS. 1 to 3, the support device 122 is adapted to be disposed within the enclosed structure 100. The support device 122 is adapted to be inserted between the opening 110 of the first plate 102 and supported on the second plate 104. Further, the support device 122 is adapted to support the backing member 112 from inside of the enclosed structure 100 for welding the first plate 102 along the opening 110. Specifically, the support device 122 is adapted to be engaged with the second surface 112B of the backing member 112 to support the backing member 112 within the enclosed structure 100. The support device 122 is rotatable about a rotation axis ‘RA’ defined along a length thereof.

The support device 122 includes a first support member 124 having a first end 126 and a second end 128. The first support member 124 defines a first channel 130 extending from the first end 126 along a first direction “D1”. The first support member 124 further defines a second channel 132 extending from the second end 128 along a second direction ‘D2’ opposite to the first direction “D1”. In the illustrated embodiment, the first support member 124 has a circular cross section defining an outer diameter ‘A1’. The outer diameter ‘A1’ is smaller than the second width ‘W2’ of the opening 110 such that the first support member 124 may be inserted through the opening 110. In other embodiments, the cross section of the first support member 124 may be square, rectangular, elliptical, polygonal or any other suitable shape.

The support device 122 further includes a second support member 134 adjustably coupled to the first support member 124 to adjust a length between a first end 126 of the first support member 124 and an end 136 of the second support member 134 distal to the first support member 124. In the illustrated embodiment, the second support member 134 has a circular cross section defining an outer diameter ‘A2’. The outer diameter ‘A2’ is smaller than the second width ‘W2’ of the opening 110 such that the second support member 134 may be inserted through the opening 110. In other embodiments, the cross section of the second support member 134 may be square, rectangular, elliptical, polygonal or any other shape.

The second support member 134 further includes a protruding portion 138 adapted to be at least partly received within the second channel 132 of the first support member 124. In an embodiment, the second support member 134 may include threads (not shown) adapted to engage with corresponding threads (not shown) of the first support member 124. Further, a length of the protruding portion 138 received within the second channel 132 of the second support member 134 may be varied such that a length of the support device may be adjusted based on the height ‘H’ of the enclosed structure 100. The support device 122 further includes a magnet member 140 attached to the end 136 of the second support member 134 distal to the first support member 124. The magnet member 140 is adapted to detachably couple the second support member 134 to the second plate 104 of the enclosed structure 100. In an embodiment, the magnet member 140 is attached to the second support member 134 via adhesives. However, in various alternate embodiments, the magnet member 140 may be coupled to the second support member 134 via welding, fasteners, and the like.

The support device 122 further includes a pusher member 142. The pusher member 142 is configured to contact the backing member 112. The pusher member 142 includes a pushing portion 144. In the illustrated embodiment, the pushing portion 144 is an elongate member having a circular cross section. The pushing portion 144 has a diameter ‘A3’. The diameter ‘A3’ is less than the second width ‘W2’ of the opening 110 such that the pushing member 142 may be inserted through the opening 110. In other embodiments, the cross section of the pushing portion 144 may be circular, rectangular, elliptical, polygonal or any other suitable shape. In the illustrated embodiment, the outer diameter ‘A1’ of the first support member 124, the outer diameter ‘A2’ of the second support member 134, and the diameter ‘A3’ of the pushing portion 144 are substantially equal.

The pushing portion 144 further includes an abutment surface 147. The abutment surface 147 of the pushing portion 144 is adapted to abut the second surface 112B of the backing member 112. The pusher member 142 further includes an elongate portion 146 extending from the pushing portion 144 along the second direction ‘D2’. The elongate portion 146 is adapted to be at least partially received within the first channel 130 of the first support member 124. In the illustrated embodiment, the elongate portion 146 includes a plurality of teeth 148. The pusher member 142 further defines a cord channel 149 to receive a portion of a cord member 154 therethrough. The cord member 154 is coupled to the pusher member 142. In an embodiment, the cord member 154 is coupled to the pusher member 142 via adhesives. Alternatively, a thick portion (not shown) may be formed at the end of the cord member 154. The thick portion of the cord member 154 may be received in a wide portion 155 of the cord channel 149 to detachably couple the cord member 154 with the pusher member 142. However, in various alternate embodiments, the cord member 154 may be coupled to the pusher member 142 via various other methods, such as retaining projections, fasteners, and the like. The cord member 154 is adapted to move the pusher member 142 along the second direction ‘D2’. Further, the cord member 154 may also be adapted to dispose the backing member 112 inside the enclosed structure 100.

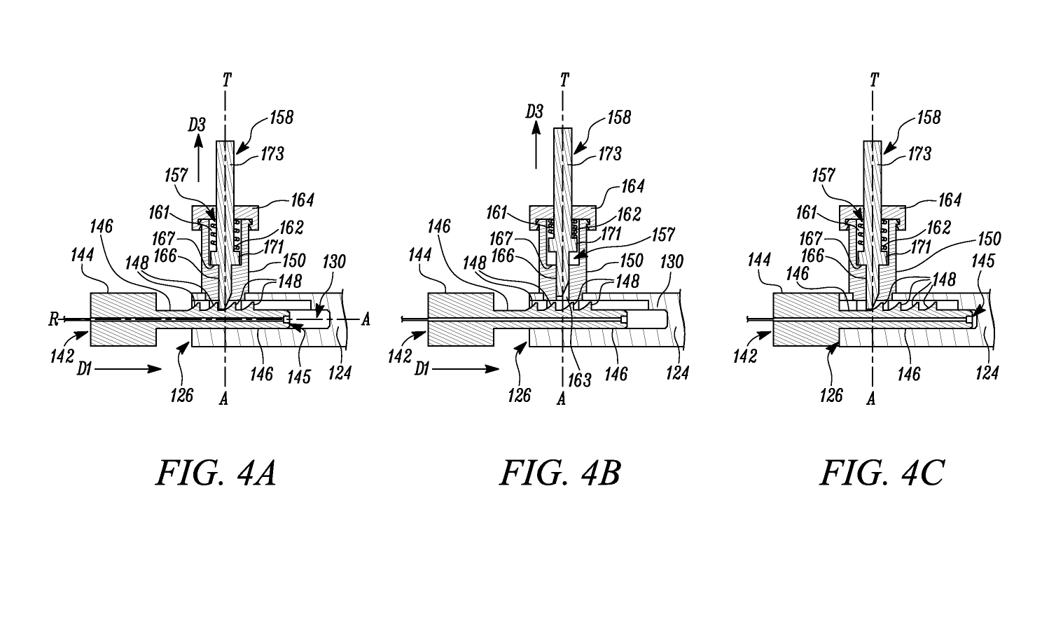

Referring to FIGS. 4A to 4C, the support device 122 further includes a housing 150 coupled to the first support member 124 proximal to the first end 126. The housing 150 may be coupled to the first support member 124 via various methods such as welding, adhesives, fasteners, and the like. In an alternate embodiment, the housing 150 and the first support member 124 may be a unitary component. The housing 150 further defines a cavity 157 defining a transverse axis ‘TA’ perpendicular to the rotation axis ‘RA’. The cavity 157 includes a first portion 161 and a second portion 163 adjacent to the first portion 161. Further, the second portion 163 is proximal to the first support member 124. In the illustrated embodiment, a diameter of the second portion 163 is less than a diameter of the first portion 161. Further, a flange 171 is formed at an interface between the first portion 161 and the second portion 163.

The system 101 further includes a pin member 158 at least partly received within the housing 150. The pin member 150 is disposed substantially perpendicular with respect to the elongate portion 146 of the pusher member 142. The pin member 158 includes a first pin portion 166 adapted to be received within the second portion 163 of the cavity 157. The pin member 158 further includes a flange portion 167 supported on the flange 171 of the housing 150. Therefore, a movement of the pin member 158 along the transverse axis ‘TA’ towards the pusher member 142 is prevented. The pin member 158 also includes a second pin portion 173 partly received within the second portion 163 of the cavity 157.

The pin member 158 is adapted to selectively engage with one of the teeth 148 of the elongate portion 146 to allow unidirectional incremental movement of the pusher member 142 along the second direction ‘D2’. Specifically, the pin member 158 and each of the teeth 148 form a ratchet and pawl arrangement that allows incremental movement of the pusher member 142 along the second direction ‘D2’. Further, movement of the pusher member 142 along the first direction ‘D1’ is prevented once the pin member 158 is engaged with one of the teeth 148 of the elongate portion 146.

The support device 122 also includes a spring member 162 received within the second portion 163 of the housing 150. The spring member 162 is configured to bias the pin member 158 into engagement with one of the teeth 148 of the elongate portion 146. Further, the system 101 includes a cap member 164 coupled to the housing 150. In the illustrated embodiment, the cap member 164 is coupled to the housing 150 via locking projections 165. Alternatively, the cap member 164 may be coupled to the housing 150 via a threaded coupling, fasteners, adhesives, welding, and the like. The cap member 164 is adapted to retain the spring member 162 within the housing 150. In the illustrated embodiment, the spring member 162 is supported between the flange portion 167 of the pin member 158 and a wall of the cap member 164. In the illustrated embodiment, the spring member 162 is a coil spring. Further, the cap member 164 defines an opening such that the second pin portion 173 may extends out of the cap member 164. The second pin portion 173 may be moved along the transverse axis ‘TA’ against the biasing force of the spring member 162 in order to disengage the pin member 158 from the teeth 148 of the elongate portion 146.

As shown in FIG. 4A, an end 145 of the elongate portion 146 is spaced apart form the second end 128 of the first support member 124. The first pin portion 166 is engaged with one of the teeth 148 located in an intermediate position along the elongate portion 146. As shown in FIG. 4B, the pin member 158 is moved along the transverse axis ‘TA’ perpendicular to the first direction ‘D1’ such that the pin member 158 may disengage with the teeth 148 of the elongate portion 146. Thereafter, as shown in FIG. 4B, the pusher member 142 is moved along the second direction ‘D2’ within the first channel 130 of the first support member 124. As shown in FIG. 4C, the second pin portion 173 released such that the spring member 162 biases the pin member 158 into engagement with the tooth 148 located adjacent to the pushing portion 144. In a similar manner, the pin member 158 may be disengaged from the teeth 148 and the pusher member 142 adjusted within the first channel 130 such that the pin member 158 is engaged with a suitable tooth 148. This enables a length of the support device 122 to be varied based on the height ‘H’ of the enclosed structure 100.

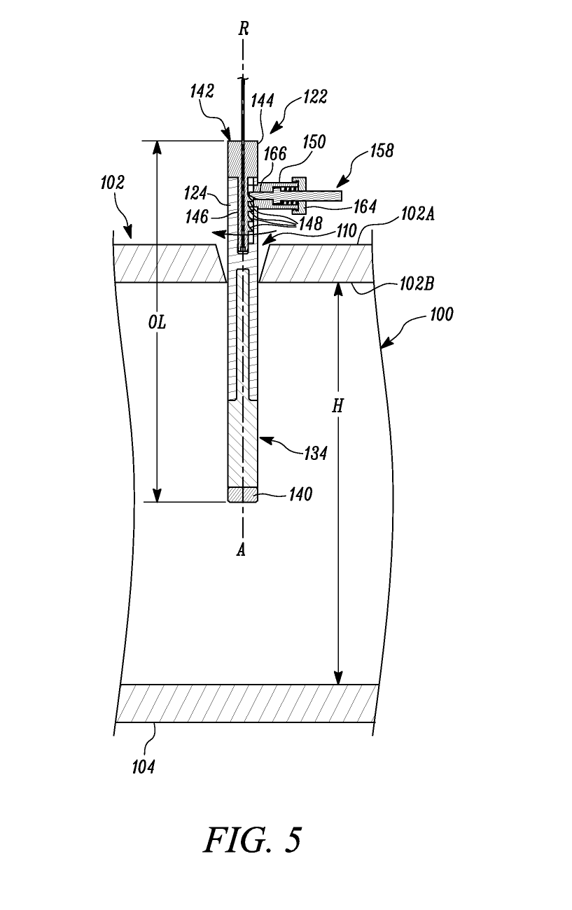

Referring to FIGS. 4C and 5, the support device 122 defines an overall length ‘OL’ extending between the abutment surface 147 of the pusher member 142 and the magnet member 140. The overall length ‘OL’ of the support device 122 is less than the height ‘H’ of the enclosed structure 100 such that the support device 122 may be vertically disposed between the first and second plates 102, 104 of the enclosed structure 100.

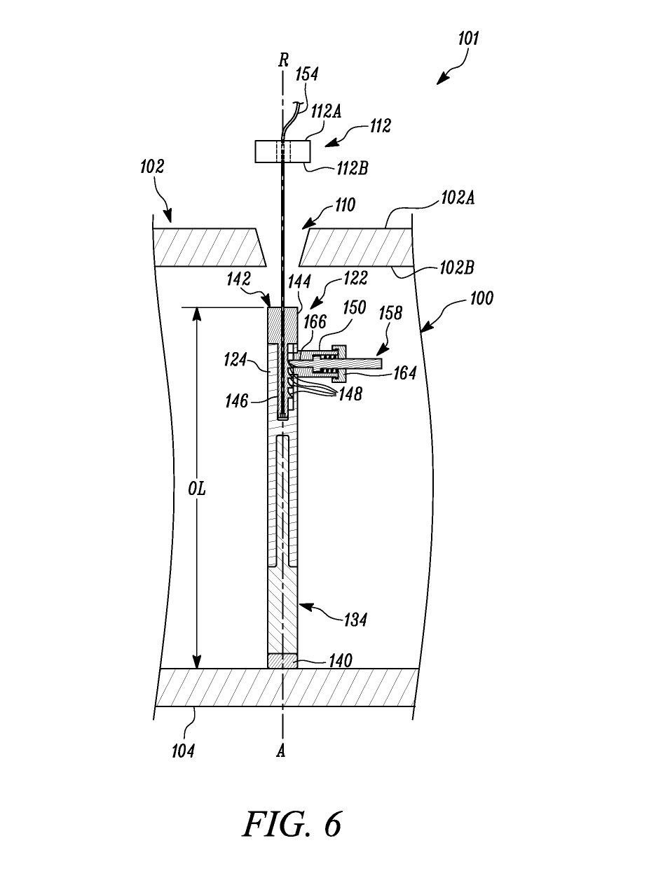

FIGS. 5 and 6 illustrate an exemplary method of disposing the support device 122 within the enclosed structure 100. The support device 122 is inserted through the opening 110. In an exemplary embodiment, the enclosed structure 100 may be located on a work surface (not shown) and the opening 110 is defined in the first plate 102. The opening 110 is defined at a location in the enclosed structure 100 where a cracking failure is occurred. In an embodiment, the opening 110 may be defined by a gouging process, such as air carbon arc gouging or plasma gouging. However, in other embodiments, the opening 110 may be defined by various machining process, such as drilling, milling, grinding, filing, tapering or a combination thereof.

Referring to FIGS. 1 and 5, the support device 122 is inserted within the enclosed structure 100 through the opening 110 at a first orientation. In the first orientation, the housing 150 and the pin member 158 are aligned at an angle with respect to the longitudinal axis ‘LA’ of the opening 110. The support device 122 is then rotated about the rotation axis ‘RA’ such that the housing 150 is aligned with the longitudinal axis ‘LA’ of the opening 110.

As shown in FIGS. 5 and 6, the support device 122 is inserted within the enclosed structure 100 while supported by the cord member 154. Further, the magnet member 140 attached to the end 136 of the second support member 134 is adapted to contact the second plate 104 of the enclosed structure 100. As the overall length ‘OL’ of the support device 122 is less than the height ‘H’ of the enclosed structure 100, once the support device 122 is vertically disposed within the enclosed structure 100, the backing member 112 may be inserted within the enclosed structure 100 through the opening 110 and supported on the pusher member 142.

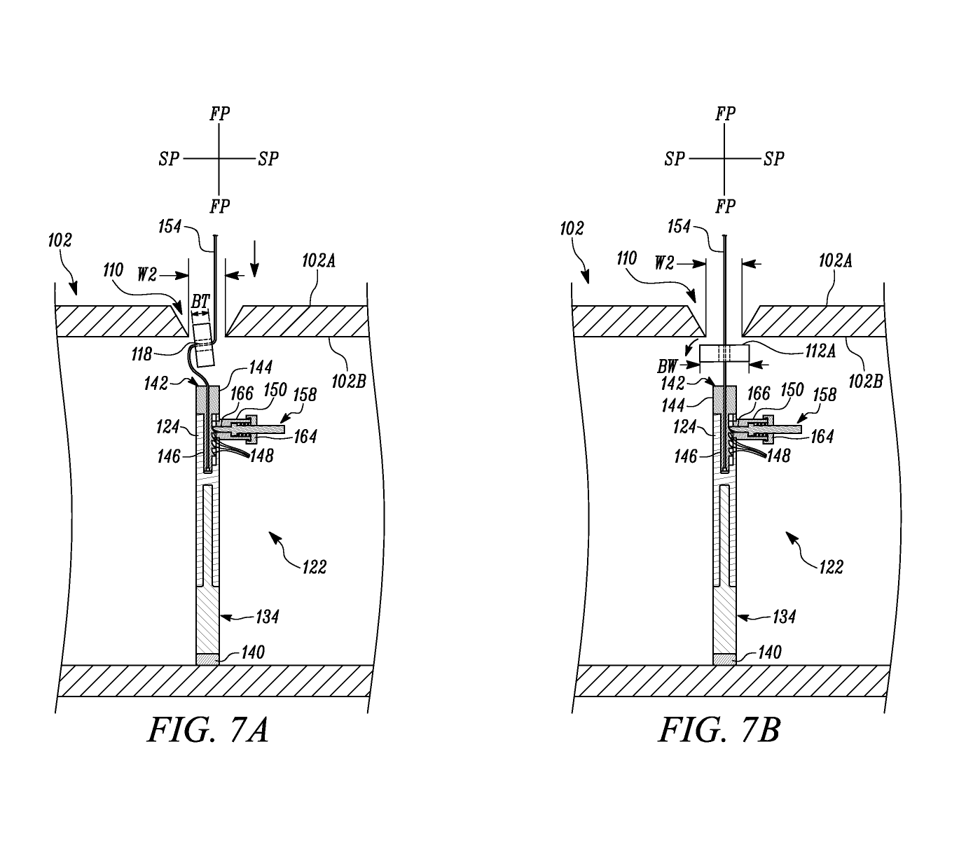

FIGS. 7A and 7B illustrate an exemplary method of disposing the backing member 112 within the enclosed structure 100. Referring to FIGS. 2 and 7A, the backing member 112 is inserted within the enclosed structure 100 through the opening 110. The cord member 154 is inserted through each of the plurality of second through holes 118 to hold the backing member 112 in a first position ‘FP’. The cord member is inserted through the second through holes 118 such that a loop is formed. In an embodiment, another string may also may also be inserted through one of the through holes 118 during insertion of the backing member 112. This may enable actuation of the pusher member 142 by the cord member 154 after insertion of the backing member 112.

In the first position ‘FP’, as illustrated in FIG. 7A, a plane defined by the width ‘BW’ of the backing member 112 is oriented perpendicular to the longitudinal axis ‘LA’. Further, the thickness ‘BT’ of the backing member 112 is aligned with the second width ‘W2’ of the opening 110. As the thickness ‘BT’ of the backing member 112 is less than the second width ‘W2’ of the opening 110, the backing member 112 may be inserted within the enclosed structure 100 through the opening 110. Further, as the length ‘BL’ of the backing member 112 is longer than the length of the opening 110, one end of the backing member 112 is inserted through the opening 110 initially to dispose the backing member 112 within the enclosed structure 100.

Further, as shown in FIG. 7B, the backing member 112 is allowed to move from the first position ‘FP’ to a second position ‘SP’ due to self-weight. In the second position ‘SP’, the backing member 112 is aligned with the opening 110 and the plane defined by the width ‘BW’ of the backing member 112 becomes parallel to the first plate 102.

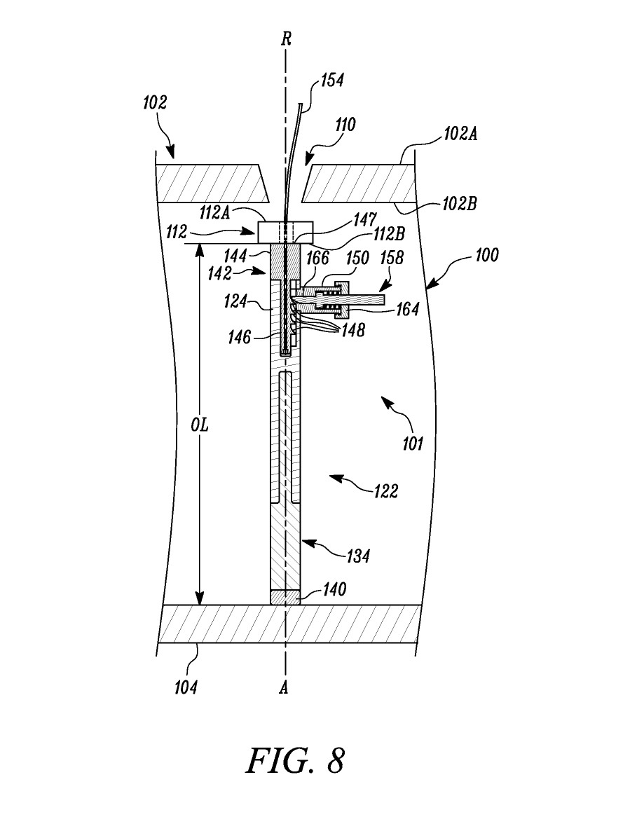

Referring to FIG. 8, the backing member 112 is further moved towards the first plate 102 along the rotation axis ‘RA’ to contact the backing member 112 with the first plate 102. The cord member 154 is pulled upwards such that the first surface 112A of the backing member 112 contacts with the inner surface 102B of the first plate 102. Thus, the opening 110 is closed from inside of the enclosed structure 100 by the backing member 112.

FIGS. 8 and 9 illustrate an exemplary method of engaging the system 112 with the enclosed structure 100. As shown in FIG. 8, the backing member 112 is moved towards the pusher member 142 along the rotation axis ‘RA’ to contact the abutment surface 146 of the pusher member 142. As shown in FIG. 9, the cord member 154 is pulled upwards to move the pusher member 142 along the second direction ‘D2’ to bias the backing member 112 into contact with the first plate 102 to close the opening 110 from inside within the enclosed structure 100. Specifically, the first surface 112A of the backing member 112 contacts with the inner surface 102B of the first plate 102. In the illustrated embodiment, the elongate portion 146 moves within the first channel 130 such that the pin member 158 engages a tooth 148 located at an intermediate position along the elongate portion 146. Thus, the opening 110 is closed from inside of the enclosed structure 100 by the backing member 112. Further, portions of the cord member 154 lying outside the enclosed structure 100 may be cut. Remaining portions of the cord member 154 may melt along with the welding material during welding of the first plate 102.

### INDUSTRIAL APPLICABILITY

The present disclosure relates to the system 101 to assist the operator to weld the first plate 102 of the enclosed structure 100. The system 101 is disposed within the enclosed structure 100 to close the opening 110 via the backing member 112 and supporting the backing member 112 via the system 101. According to the present disclosure, as the support device 122 is inserted through the opening 110, the backing member 112 is supported from inside of the enclosed structure 100 without any additional modification in the enclosed structure 100. Thus, welding of the enclosed structure 100 is performed from outside of the enclosed structure 100 in a short duration at lower costs. Further, inspection of the weld quality is also performed from outside of the enclosed structure 100.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A system for facilitating welding along an opening defined in a first plate of an enclosed structure, the enclosed structure further having a second plate spaced apart from the first plate, the system comprising:
a support device adapted to be inserted between the opening of the first plate and supported on the second plate, the support device comprising:
a first support member having a first end and a second end, the first support member defining a channel extending from the first end along a first direction;
a second support member adjustably coupled to the first support member to adjust a length between a first end of the first support member and an end of the second support member distal to the first support member;
a magnet member attached to the end of the second support member distal to the first support member, the magnet member adapted to detachably couple the second support member to the second plate of the enclosed structure;
a pusher member comprising a pushing portion and an elongate portion extending from the pushing portion, wherein the elongate portion adapted to at least partly received within the channel, and wherein the elongate portion comprises a plurality of teeth;
a housing coupled to the first support member proximal to the first end thereof;
a pin member at least partly received within the housing, the pin member adapted to selectively engage with one tooth of the plurality of teeth of the elongate portion to allow unidirectional incremental movement of the pusher member along a second direction opposite to the first direction, wherein the pin member is disposed substantially perpendicular with respect to the elongate portion of the pusher member;
a spring member received within the housing, the spring member configured to bias the pin member into engagement with one tooth of the plurality of teeth of the elongate portion; and
a cord member coupled to the pusher member, the cord member adapted to move the pusher member along the second direction; and
a backing member adapted to close the opening from within the enclosure, wherein the backing member is inserted through the opening and supported on the pushing portion of the pusher member, and wherein the cord member is pulled to move the pusher member along the second direction to bias the backing member into contact with the first plate to close the opening from inside within the enclosure.
